(19) United States
(12) Patent Application Publication
(10) Pub. No.: US 2023/0264710 A1
(43) Pub. Date: Aug. 24, 2023

(54) Method for Determining a Speed of an Object Using an Ultrasonic Pulse

(71) Applicant: Robert Bosch GmbH, Stuttgart (DE)

(72) Inventors: Katharina Maria Nerz, Heimsheim (DE); Wilhelm Christopher Von Rosenberg, Muenchen (DE); Andrea Kirsch, Stuttgart (DE); Ulf Rueegg, Stuttgart (DE); Timo Winterling, Stuttgart (DE); Sebastian Olbrich, Leonberg (DE); Kathrin Klee, Stuttgart (DE)

(21) Appl. No.: 17/999,748

(22) PCT Filed: Apr. 22, 2021
(86) PCT No.: PCT/EP2021/060563

§ 371 Date: Nov. 23, 2022

(30) Foreign Application Priority Data
May 27, 2020 (DE) 10 2020 206 622.1

(51) Int. Cl. B60W 60/00; G01S 15/58; G01S 15/931; B60W 40/02; B60W 50/14

(52) U.S. Cl. CPC B60W 60/001; B60W 40/02; B60W 50/14; G01S 15/582; G01S 15/931; B60W 2554/404

(57) ABSTRACT

A method is for determining a speed of an object based on an ultrasonic pulse. The method includes emitting the ultrasonic pulse using a first ultrasonic transducer. The ultrasonic pulse having a defined signal profile. The method further includes receiving an ultrasonic signal using a second ultrasonic transducer, calculating a cross-correlation, with respect to frequency, of the ultrasonic signal with a filter signal which at least partially correlates with the defined signal profile, and determining a frequency shift between the filter signal and the received ultrasonic signal using a result of the calculated cross-correlation. The method also includes determining the speed of the object which reflected the emitted ultrasonic pulse using the determined frequency shift.

### PRIOR ART

Perceiving or representing the surroundings (perception) is very important for implementing at least partially automated driving. In the process, the surroundings are detected by means of sensors.

Both for driver assistance systems, but also in particular in the field of at least partially automated driving, it is important to recognize relevant objects in the vicinity of a vehicle, for example other road users, namely pedestrians, cyclists, passenger cars, trucks, etc., or possible obstacles such as a fence, pillar, wall, etc., in order to prevent collisions. Furthermore, the system must be configured to always be able to react in accordance with legislation.

For this near range, the transit times or ultrasonic echoes of ultrasonic pulses between the transmitter, the reflection location, and the receiver are measured in current ultrasonic systems. An ultrasonic sensor can simultaneously be a transmitter and receiver in the same measuring cycle. The spatial coordinates of reflection points of the reflecting object can be determined by means of a suitable combination or tri- or multilateration of a plurality of such ultrasonic echoes. If the transmitting or receiving ultrasonic sensors are arranged not only in a horizontal sensor array but additionally vertically with respect to one another, z-coordinates, i.e., height information, can also be determined in addition to x- and y-positions.

### DISCLOSURE OF THE INVENTION

Typically, in today’s driver assistance and parking systems, the ultrasonic sensors or ultrasonic transducers are primarily installed horizontally with respect to one another and the resulting x- and y-position data have hitherto only been used either to detect possible obstacles or, on the basis of the vehicle surroundings, to calculate a parking maneuver. In addition to these position data, however, no further information relating, for example, to the speed of the detected objects is available to the system.

Thus, a static environment is typically assumed or a potential intrinsic movement of the reflecting objects is disregarded, i.e., all detected objects are assumed to be motionless due to a lack of alternatives.

In order to determine the speed by means of ultrasonic signals, it would be possible to combine ultrasonic signals by means of a temporal analysis, based on two associated, temporally successive ultrasonic signals so as to form an ultrasonic signal pair, in order to be able to infer a relative speed. However, due to ambiguities or miscalculations frequently occurring in this analysis method, this approach is not practicable and reliable enough to be used in road traffic.

According to the invention, a method for determining a speed of an object by means of an ultrasonic pulse, a method for providing a control signal, a device, a computer program, and a machine-readable storage medium according to the features of the independent claims are proposed. Advantageous embodiments are the subject matter of the dependent claims and the following description.

The invention is based on the knowledge that a Doppler shift of the frequency of the ultrasonic pulse is brought about by an object which moves toward or away from an ultrasonic transducer and which reflects an ultrasonic pulse. In particular, the Doppler effect results in an increase in the frequency at a positive relative speed and a decrease in the frequency of the received ultrasonic signals at a negative relative speed. This effect can be used to determine the speed of the object in question relative to the receiving sensor.

Throughout this description of the invention, the sequence of method steps is shown in such a way that the method is easy to understand. However, a person skilled in the art will recognize that many of the method steps can also be run through in a different order and produce the same result. In this sense, the order of the method steps can be changed accordingly and is thus also disclosed.

According to one aspect, a method for determining a speed of an object by means of an ultrasonic pulse having the following steps is proposed. In a first step, the ultrasonic pulse is emitted by means of a first ultrasonic transducer, the ultrasonic pulse having a defined signal profile. In a further step, an ultrasonic signal is received by means of a second ultrasonic transducer. In a further step, a frequency-related cross-correlation of the ultrasonic signal with a filter signal which at least partially correlates with the defined signal profile is calculated. In a further step, a frequency shift between the filter signal and the received ultrasonic signal is determined by means of a result of the calculated cross-correlation. In a further step, the speed of the object which reflected the emitted ultrasonic pulse is determined by means of the determined frequency shift.

In this case, the ultrasonic pulse having the defined signal profile is a sound signal emitted by the ultrasonic transducer in the direction of objects that may reflect ultrasound and having a frequency in the ultrasonic range, the signal profile being defined with respect to a temporal and frequency-related profile.

The signal profile of the ultrasonic pulse is matched to the profile of the filter signal in order to be able to determine a clear result with respect to a frequency shift of the emitted ultrasonic pulse in relation to the received ultrasonic signal by means of the frequency-related cross-correlation. The defined signal profile can, in particular, have a temporal change and/or a temporal change in the frequency of the like that produces a clear maximum with respect to the temporal and frequency-related cross-correlation during the calculation of the temporal and frequency-related cross-correlation of the ultrasonic signal with the filter signal.

In particular, the first ultrasonic transducer may be the same as the second ultrasonic transducer, since, typically, the ultrasonic transducers are suitable both as a transmitter and as a receiver of ultrasound and can convert a received ultrasonic signal into electrical signals, which can then be further evaluated. However, the ultrasonic pulse can also be emitted simultaneously by one or more ultrasonic transducers and be detected or received by a plurality of identical or additional ultrasonic transducers.

A relative speed vᵣₑₗ of the object that reflected the emitted ultrasonic pulse with the frequency f_{USP} with respect to the received ultrasonic transducer that receives the ultrasonic signal with the frequency f_{USE} can be calculated as follows on the basis of the Doppler shift according to the mathematical physical relationship:

$${\text{f}}_{\text{USE}} = {\text{f}}_{\text{USP}} * \left({\text{c}}_{\text{s}} + {\text{V}}_{\text{rel}}\right) / \left({\text{c}}_{\text{s}} - {\text{V}}_{\text{rel}}\right)$$

where cₛ is the speed of sound.

Advantageously, using this method, the relative speed of the reflected object can additionally be detected as a direct measurement variable by means of the frequency shift Δf for each individual echo and does not have to be derived using a complex tracking method or an echo pair grouping analysis, with the associated delay times, ambiguities, and/or incorrect associations.

Generally, ultrasonic systems measure transit times of a transmitted ultrasonic pulse from an emitting ultrasonic transducer to the reflecting object and back to a receiving ultrasonic transducer.

Therefore, using the method, the relative speed of the detected object can thus be determined in addition to data measured by ultrasonic systems, such as echo distances, backscatter values, trace probability, etc.

This gain in information is advantageous, in particular for a possible field of application in at least partially automated driving, especially since it also makes it possible to perceive the surroundings of the vehicle in a significantly more differentiated manner, since a distinction between a static object or dynamic object at a constant speed or constant acceleration and/or “constant heading”, etc., is made possible. Therefore, by virtue of this method, the immediate vehicle surroundings can be comprehensively detected and possible obstacles or other road users can be reliably detected and located using ultrasonic systems.

As a result, the speed of a reflecting object is already available in the first or the same measuring step, i.e., in real time. A distinction between the measured ultrasonic objects in relation to a static or dynamic behavior is thus advantageously possible.

Furthermore, two previously temporally unresolvable ultrasonic signals or ultrasonic echoes can additionally be separated by means of the local maximum of the cross-correlation in the frequency range. In other words, on account of the frequency shift of an ultrasonic signal with respect to the emitted ultrasonic pulse, two simultaneously received ultrasonic signals, for example from two obstacles at the same distance, can be separated by means of a potentially different frequency shift due to potentially different relative speeds with respect to the ultrasonic system.

With this gain in information, vehicle surroundings can be perceived in a significantly more differentiated manner, since the identified objects that reflect the ultrasonic pulse can be distinguished in relation to static or dynamic behavior such as constant speed, constant acceleration, “constant heading”, determination of trajectories, etc.

In particular, a “constant heading” can be deduced by means of two temporally successive ultrasonic signals generated by the same transmitter/receiver pair of ultrasonic transducers, with a known speed and known change in the reflection point distance with time.

The improved assignment of received ultrasonic signals, which is possible with the speed information, also results in improved determination of the reflection points.

In particular, a determination of the point in time independent of the frequency shift and thus the distance of the received ultrasonic signal leads to improved determination of the reflection points.

Echo selection can also be improved by means of the additional information about the speed of the reflecting object. In order to determine a position of (multi-)objects, the individual received ultrasonic signals must be combined with one another or laterated. In order to save computation resources and to reduce the complexity, physically unrealistic ultrasonic signal combinations are firstly ruled out. In addition to the previous geometric consideration based on distance values, the speed value can now additionally be used. This also makes it possible to effectively separate two ultrasonic signals that are temporally close to one another at different speeds. In addition, it is possible to assign relative speeds to the reflection points on the basis of the information about the ultrasonic signals.

According to one aspect, it is proposed that a temporal and frequency-related cross-correlation of the ultrasonic signal with the filter signal is calculated.

A two-dimensional correlation of this kind, i.e., a cross-correlation between a defined signal profile of the ultrasonic pulse g and a filter signal a, which is carried out both in the time and in the frequency range, can be calculated mathematically in the following manner:

$$\begin{matrix}\left(g ∗ h\right) \left({t}_{0} , {f}_{0}\right) = ∬ \overline{g \left(t , f\right)} h \left(t + {t}_{0} , f + {f}_{0}\right) d t d f = \\ ∬ \overline{g \left(t + {t}_{0} , f + {f}_{0}\right)} h \left(t , f\right) d t d f\end{matrix}$$

Accordingly, the following results for a calculation in discrete time steps:

$$\begin{matrix}\left(g ∗ h\right) \left({t}_{0} , {f}_{0}\right) = {\sum }_{{t}_{0} , {f}_{0}} \overline{g \left(t , f\right)} h \left(t + {t}_{0} , f + {f}_{0}\right) = \\ {\sum }_{{t}_{0} , {f}_{0}} \overline{g \left(t + {t}_{0} , f + {f}_{0}\right)} h \left(t , f\right)\end{matrix}$$

The defined signal profile can, in particular, have a temporal change and/or a temporal change in the frequency which is such that, during the calculation of the temporal and frequency-related cross-correlation of the ultrasonic signal with the filter signal, a clear maximum can be determined with respect to the temporal and frequency-related cross-correlation.

In other words, the filter signal is selected according to a “matched filter” in order to achieve unambiguous cross-correlation results or in order for the filter signal and ultrasonic signal to be able to be exactly superimposed in time and in frequency. However, for this purpose, the filter signal does not have to have the identical shape of the emitted ultrasonic pulse. Examples of such defined signal profiles of the ultrasonic pulse are a simple frequency ramp over time, a signal profile in which the frequency increases linearly in time (up-chirp) and decreases again (down-chirp), or the reverse shape, i.e., the frequency decreases linearly over time in a first time interval and then increases again linearly. A temporally defined ultrasonic pulse with a constant frequency over a certain period of time can also be used, since the correlation is determined both in terms of time and frequency.

A two-dimensional plot of the values of the correlation over time and frequency can be created from such a two-dimensional correlation in time and frequency and can have a plurality of maxima. Both the transit time of an ultrasonic pulse and a frequency shift of the received ultrasonic signal with respect to the emitted ultrasonic pulse can then be read from this plot.

A distance dₛ of a reflecting object from the ultrasonic transducer can be calculated from the correlation in time:

$${\text{d}}_{\text{s}} = {\text{c}}_{\text{s}} * \left({\text{t}}_{\text{D}} {\text{- t}}_{0}\right) / 2$$

where cₛ is the speed of sound and t_{D} is the point in time at which the ultrasonic signal is received and t₀ is the point in time at which the ultrasonic pulse is emitted.

According to one aspect, it is proposed that a frequency of the defined signal profile changes over time.

Due to this change in the signal profile over time, the received ultrasonic signal can be assigned to an emitted ultrasonic pulse in a defined manner.

According to one aspect, it is proposed that the defined signal profile has a temporal change and/or a temporal change in the frequency which is such that, during the calculation of the temporal and frequency-related cross-correlation of the ultrasonic signal with the filter signal, a clear maximum results with respect to the temporal and frequency-related cross-correlation.

As a result, an ultrasonic signal having a signal profile which has a change in the frequency over time can be unambiguously assigned to an emitted ultrasonic pulse.

According to one aspect, it is proposed that the first ultrasonic transducer is the same as the second ultrasonic transducer.

According to one aspect, it is proposed that a transit time of the ultrasonic pulse is determined by means of an amplitude of a temporal component of the calculated temporal and frequency-related cross-correlation in order to locate the object that reflected the emitted ultrasonic pulse.

By means of the described two-dimensional cross-correlation, which is carried out both in time and in frequency, the transit time of an emitted ultrasonic pulse can be determined on the basis of the received ultrasonic signal and ultrasonic signals which were reflected by objects at different speeds can be distinguished by means of the additional frequency-related cross-correlation.

According to one aspect, it is proposed that the frequency shift of the ultrasonic signal is used to assign an object to the ultrasonic signal. As has already been described above, the frequency shift can be attributed to a speed difference by means of the Doppler effect and thus it is possible to distinguish objects at different speeds. This also allows for physically unrealistic combinations of ultrasonic signals for determining reflection points due to the additional information about the speed.

According to one aspect, it is proposed that the speed of an object is determined by means of the relevant frequency shift of a relevant ultrasonic signal of an ultrasonic pulse received by a plurality of ultrasonic transducers.

By means of the information about the speed of the ultrasonic signal from a reflecting object, it is thus possible to assign the relative speed and movement direction to an object from the laterated reflection points which can be assigned to an object.

According to one aspect, it is proposed that reflection points are determined by means of lateration from a plurality of ultrasonic pulses and a plurality of ultrasonic signals and the plurality of ultrasonic signals for determining reflection points are grouped by means of the frequency shift of the respective ultrasonic signals.

Ultrasonic signals are recorded by means of sensor arrays or arrays of ultrasonic transducers which can be mounted either at the front and/or at the rear and/or on the side of a vehicle. In general, the sensors of ultrasonic systems measure the transit times of an emitted ultrasonic pulse from an emitting ultrasonic transducer to the reflecting object and back to a receiving ultrasonic transducer. The receiving ultrasonic transducer may be identical to or different from the emitting ultrasonic transducer.

If a reflected ultrasonic pulse is received by a plurality of ultrasonic transducers, the position of the reflecting object can be determined by lateration of the transit paths (“echoes”) determined from the transit times. Furthermore, the sensor array may be positioned either in one or two rows in an upper row and a row arranged thereunder, which produces the advantage that, in addition to an x- and y-position, a z-position, i.e., an item of height information relating to the reflection points, can also be determined.

If a plurality of ultrasonic pulses is emitted and the individual defined signal profiles are selected such that they can be distinguished from one another, the ultrasound reflection points of the reflecting object can be determined in space via the reception of ultrasonic signals which are received, in particular, by a plurality of ultrasonic transducers, and the ultrasonic transducers are spatially separated from one another. If the ultrasonic transducers that receive the ultrasonic signals are arranged both horizontally and vertically, a three-dimensional determination of the reflection points can also be carried out.

A method is proposed which determines a frequency shift according to the method for determining a speed of an object, and a control signal for controlling an at least partially automated vehicle is provided on the basis of the determined frequency shift. Alternatively or additionally, it is proposed that a frequency shift is determined according to the method for determining a speed of an object, and a warning signal for warning a vehicle occupant is provided on the basis of the determined frequency shift.

The term “on the basis of” is to be broadly understood with respect to the feature that a control signal is provided on the basis of a determined frequency shift. It is to be understood in such a way that the determined frequency shift is used for any determination or calculation of a control signal, which does not exclude other input variables also being used for this determination of the control signal. This also applies to the warning signal.

A device is specified which is configured to carry out a method as described above. By means of a device of this kind, the method can be easily integrated into different systems.

A computer program is specified which comprises instructions which, when the computer program is executed by a computer, cause the computer to carry out one of the methods described above. Such a computer program enables the use of the described method in different systems.

A machine-readable storage medium is specified on which the above-described computer program is stored.

### EMBODIMENTS

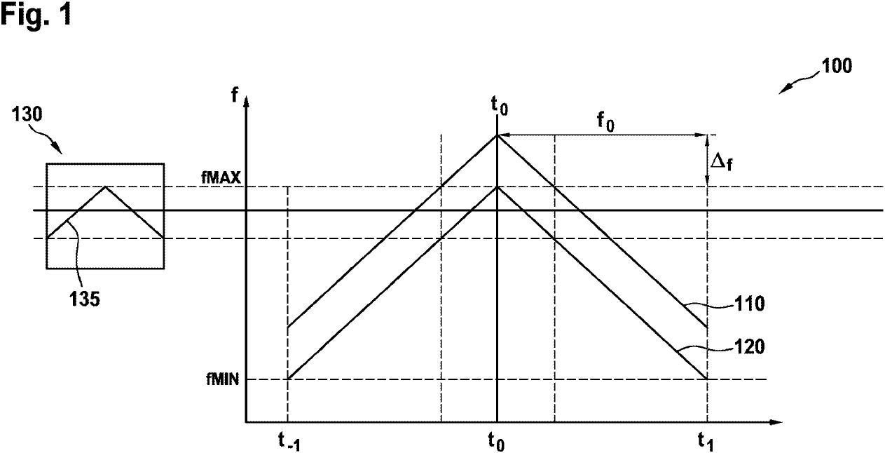

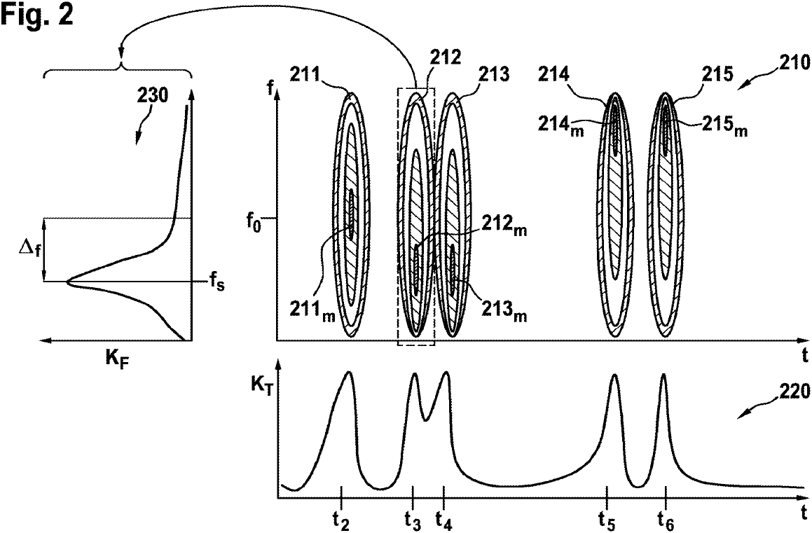

Embodiments of the invention are illustrated with reference to FIGS. 1 and 2 and explained in more detail below. In the drawings:

FIG. 1 shows a defined signal profile of an ultrasonic pulse and an ultrasonic signal which is shifted in frequency;

FIG. 2 shows a plot of a two-dimensional cross-correlation and projections.

FIG. 1 shows a time profile of an emitted ultrasonic pulse 120, i.e., a defined signal profile in which the frequency f of the ultrasonic pulse 120 starting at the point in time t₋₁ increases linearly from a value fMIN with the time t up to the point in time t₀ to a value fMAX and then the frequency decreases linearly back to the value fMIN up to the point in time t₁.

As a result of the Doppler effect, an ultrasonic signal 110 that is shifted in frequency can result from this ultrasonic pulse 120, which ultrasonic signal is additionally plotted in the graph 100 of FIG. 1. Since, in this example, the profile of the frequency of the ultrasonic pulse 120 is shifted toward higher frequencies, the object moves to the receiving ultrasonic transducer.

A possible filter signal 135 is shown in the graph 130, which has a frequency profile corresponding to the ultrasonic pulse over time, which is indicated in the graph 130 by a shape of the frequency profile 135 over time that corresponds to the profile of the signal of the ultrasonic pulse.

It can be seen in FIG. 1 that a temporal cross-correlation of the ultrasonic signal 110 with the filter signal 135 allows for unambiguous assignment of the ultrasonic signal 110 in time with this defined signal profile of the ultrasonic signal. This figure shows that a temporal cross-correlation of the ultrasonic signal 110 with the filter signal 135 would produce at the point in time t₀.

FIG. 2 outlines one possible result of a two-dimensional cross-correlation in time and frequency. The result, i.e., the value, of such a cross-correlation over time t and frequency f is plotted in the graph 210. Here, five ultrasonic signals 211, 212, 213, 214, 215 can be seen, each having a maximum 211 m, 212 m, 213 m, 214 m, 215 m, which is shifted for the ultrasonic signals 212, 213, 214, 215 with respect to an ultrasonic signal 211 from a non-moving static object with the maximum 211 m at the frequency f₀. Here, the maximum of the ultrasonic signal 211 from a static object is therefore at a frequency fₛ that corresponds to that of the emitted ultrasonic pulse f₀. The two next echo signals 212, 213 in the center were reflected by an object at a negative relative speed, resulting in a decrease in frequency. The two echo signals 214, 215 on the right in the plot were reflected by an object at a positive relative speed and therefore show an increase in frequency.

This frequency shift Δf is plotted over the value K_{F} of the frequency-related cross-correlation as a projection onto the frequency axis for the ultrasonic signal 212 in the graph 230 of FIG. 2 for the purpose of clarification.

The graph 220 of FIG. 2 outlines the profile of a value K_{T} of a correlation of ultrasonic signals with the filter signal, it being possible to convert the transit times t₂, t₃, t₄, t₅, t₆ of the different ultrasonic signals 211, 212, 213, 214, 215 into a distance of the object from the relevant receiving ultrasonic transducer. In other words, the graph 220 shows a projection of the result of the two-dimensional cross-correlation onto the time range and the graph 230 shows the projection onto the frequency range.

This means that, using this method for determining a speed of an object by means of an ultrasonic pulse, an ultrasonic pulse is emitted by means of a first ultrasonic transducer which has a defined signal profile. The ultrasonic signal reflected by an object is received by a second ultrasonic transducer which may be identical to the first ultrasonic transducer. A frequency shift between the filter signal and the received ultrasonic signal can be determined as described by means of a frequency-related cross-correlation of the ultrasonic signal with the filter signal which at least partially correlates with the defined signal profile. The speed of the object that reflected the ultrasonic pulse can then be calculated according to the Doppler effect.

1. A method for determining a speed of an object based on an ultrasonic pulse, comprising:
emitting the ultrasonic pulse using a first ultrasonic transducer, the ultrasonic pulse having a defined signal profile;
receiving an ultrasonic signal using a second ultrasonic transducer;
calculating a frequency-related cross-correlation of the ultrasonic signal with a filter signal which at least partially correlates with the defined signal profile;
determining a frequency shift between the filter signal and the received ultrasonic signal based on a result of the calculated cross-correlation; and
determining the speed of the object which reflected the emitted ultrasonic pulse based on the determined frequency shift.

2. The method according to claim 1, wherein calculating the frequency-related cross-correlation includes calculating a temporal and frequency-related cross-correlation of the ultrasonic signal with the filter signal.

3. The method according to claim 1, wherein a frequency of the defined signal profile changes over time.

4. The method according to claim 2, wherein the defined signal profile has a temporal change and/or a temporal change in the frequency which is such that, during the calculation of the temporal and frequency-related cross-correlation of the ultrasonic signal with the filter signal, a clear maximum results with respect to the temporal and frequency-related cross-correlation.

5. The method according to claim 1, wherein the first ultrasonic transducer is the same as the second ultrasonic transducer.

6. The method according to claim 2, wherein a transit time of the ultrasonic pulse is determined based on an amplitude of a temporal component of the calculated temporal and frequency-related cross-correlation in order to locate the object that reflected the emitted ultrasonic pulse.

7. The method according to claim 1, further comprising:
using the frequency shift of the ultrasonic signal to assign the object to the ultrasonic signal.

8. The method according to claim 1, wherein the speed of the object is determined using a relevant frequency shift of a relevant ultrasonic signal of an ultrasonic pulse received by a plurality of the ultrasonic transducers.

9. The method according to claim 1, further comprising:
determining reflection points based on lateration from a plurality of the ultrasonic pulses and a plurality of the ultrasonic signals,
wherein the plurality of the ultrasonic signals for determining reflection points are grouped based on the frequency shift of the respective ultrasonic signals.

10. The method according to claim 1, further comprising:
providing a control signal for controlling an at least partially automated vehicle based on the determined frequency shift; and/or
providing a warning signal for warning a vehicle occupant based on the determined frequency shift.

11. The method according to claim 1, wherein a device is configured to carry out the method.

12. The method according to claim 1, wherein a computer program comprises instructions which, when the computer program is executed by a computer, cause the computer to carry out the method.

13. The method according to claim 12, wherein the computer program is stored on a non-transitory machine-readable storage medium.
